(19) United States
(12) Patent Application Publication
(10) Pub. No.: US 2024/0020409 A1
(43) Pub. Date: Jan. 18, 2024

(54) PREDICTING AND ADDING METADATA TO A DATASET

(71) Applicant: Capital One Services, LLC, McLean, VA (US)

(72) Inventors: Jennifer Kwok, Brooklyn, NY (US); Mia Rodriguez, Broomfield, CO (US); Salik Shah, Washington, DC (US)

(21) Appl. No.: 17/862,866

(22) Filed: Jul. 12, 2022

(51) Int. Cl. G06F 21/62; G06N 3/08

(52) U.S. Cl. CPC G06F 21/6245; G06N 3/08

(57) ABSTRACT

Disclosed embodiments relate to addition of tags or keywords to metadata associated with sensitive data to aid in subsequent root cause analysis regarding incorrect entry of sensitive data. Sensitive data entered into an electronic form be identified. Next, context information can be collected regarding a user that entered the data. A machine learning model can be invoked that is trained to automatically determine a tag based on the context information and a confidence score associated with the tag. The tag can be added to metadata of a data string that includes the sensitive data. A data steward can be prompted to evaluate and correct the tag when the confidence score satisfies a predetermined threshold.

### BACKGROUND

Customer service representatives/agents and customers (e.g., users) may accidentally enter sensitive information, such as personally identifiable information (PII), into the wrong form fields or locations in electronic documents. For example, customers and agents have been found prone to enter social security numbers (SSNs) and credit card numbers into incorrect portions including the note fields of electronic documents. Customers have also accidentally filled in their user names with their SSN or credit card number. Customers also incorrectly enter sensitive information such as PII in a number of other unconventional ways. When entered incorrectly, this unmasked sensitive information may end up being transmitted without proper encryption and may not be properly encrypted and stored. In some instances, this may violate federal and international regulations requiring sensitive information and PII to be properly transmitted and stored with adequate safety measures. When an entity inadvertently transmits sensitive information, that entity may suffer from a damaged reputation. If the public knows an entity violates regulations regarding proper handling of sensitive information and PII, that entity is at risk of jeopardizing public trust.

### SUMMARY

The following presents a simplified summary to provide a basic understanding of some aspects of the disclosed subject matter. This summary is not an extensive overview. It is not intended to identify key/critical elements or delineate the scope of the claimed subject matter. Its sole purpose is to present some concepts in a simplified form as a prelude to the more detailed description presented later.

According to one aspect, disclosed embodiments can include a system comprising a processor coupled to memory that includes instructions that, when executed by the processor, cause the processor to scan a data string for sensitive data entered into an electronic form, identify the sensitive data within the data string, collect context information regarding a user entering the data, invoke a machine learning model that is trained to automatically determine a tag based on the context information and a confidence score associated with the tag, add the tag to data string metadata, compare the confidence score to a predetermined threshold, and prompt a human data steward to evaluate and correct the tag when the confidence score satisfies a predetermined threshold. The instructions can further cause the processor to invoke a second machine learning model trained to identify the sensitive data within the data string. In one instance, the electronic form is presented on a web page, and the user entering the data is a customer service agent. The context data can comprise at least one of a position within an organizational hierarchy, work hours, work location, or time of day. Further, the context data can comprise one or more statistics regarding historical entry accuracy and biometric behavior interaction data. The instructions can also cause the processor to at least one of mask, encrypt, or obfuscate the sensitive data before the actual sensitive data is transmitted or stored. Further, the instructions can cause the processor to update the machine learning model based on input provided by the data steward. In one scenario, the sensitive data can comprise personally identifiable information.

In accordance with another aspect, disclosed embodiments can pertain to a method executing on at least one processor instructions that cause the at least one processor to perform operations. The operations can include identifying sensitive data in a data string entered into an electronic form, acquiring context information regarding a user entering the data in the electronic form, invoking a machine learning model that is trained to automatically determine a tag based on the context information and provide a confidence score associated with the tag, adding the tag to data string metadata, comparing the confidence score to a predetermined threshold, and prompting data steward to evaluate and correct the tag when the confidence score satisfies a predetermined threshold. The operations can further comprise performing natural language processing to identify the sensitive data. Further, the operations can comprise identifying the sensitive data entered into an unprotected form field that is transmitted or stored in an unaltered state. In one scenario, the sensitive data can be entered into a comment form field. The operations can also comprise at least one of masking, encrypting, or obfuscating the sensitive data before the actual sensitive data is transmitted or stored. Furthermore, the operations can comprise updating the machine learning model based on input from the human data steward as well as invoking a convolutional neural network as the machine learning model.

According to yet another aspect, disclosed embodiments can include a computer-implemented method, comprising identifying sensitive data in a data string in an electronic form field, determining context information regarding a user entering the data into the electronic form field, executing a machine learning model trained to automatically determine a keyword based on the context and produce a confidence score associated with the keyword, adding the keyword to data string metadata, and prompting a human data steward to evaluate and correct the keyword when the confidence score satisfies a predetermined threshold. The computer-implemented method further comprises determining at least one position within an organizational hierarchy, work hours, work location, time of data, historical entry accuracy, or biometric behavior interaction data as the context information. Furthermore, the method can comprise initiating root cause analysis with respect to incorrect input of sensitive data based on the keyword.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

The accompanying drawings, which are incorporated in and constitute a part of the specification, illustrate various example methods and other example configurations of various aspects of the claimed subject matter. It will be appreciated that the illustrated element boundaries (e.g., boxes, groups of boxes, or other shapes) in the figures represent one example of the boundaries. It is appreciated that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an overview of an example implementation.

FIG. 2 is a block diagram of a sensitive information monitoring system.

FIG. 3 is an example that illustrates parts of an example string of data.

FIG. 4 is a block diagram of an example machine learning model.

FIG. 5 is a block diagram of another sensitive information monitoring system.

FIG. 6 is a flow chart diagram of a sensitive information monitoring method.

FIG. 7 is a flow chart diagram of a sensitive information monitoring method using a convolutional neural network (CNN).

FIG. 8 is a flow chart diagram of another sensitive information monitoring method.

FIG. 9 is a block diagram illustrating a suitable operating environment for aspects of the subject disclosure.

### DETAILED DESCRIPTION

The claims of this disclosure relate to tagging sensitive information (e.g., information data) for better training of machine learning models. A machine learning model may be constructed with a variety of different inputs. For example, the inputs to the machine learning model may include existing metadata including internal or external origin source of the data, transformation information of the data, context around the flagged sensitive information, volume of data, etc. Other inputs may include research conducted by a performing data steward who manually tags/attributes at least some of the data lineage. As used here, a data steward is a person that monitors data input to the machine learning model to correct inaccurate data. Another input to the machine learning model may include natural language processing (NLP) data of the context around a piece of data (e.g., if it is a comment field, any notes about recoveries versus acquisitions would provide a clue where the data originated from). Additionally, the internet protocol (IP) address or device type when data was captured can also be input for the machine learning model.

The outputs of the machine learning model include tagged datasets with a predicted origin source for better tracking of where the detected sensitive information came from. These can be keywords and may include phrases such as “agent tool”, “customer”, “agent”, other tools or software involved in entering sensitive information, and the like. There can also be a risk score (e.g., confidence values) on the confidence of the prediction of whether sensitive information is present. For low confidence values/risk scores, data stewards can manually validate the prediction and accept or reject the prediction to improve future predictions. One goal is to use keywords to determine where there is a high volume of violations and implement solutions to solve the problem at the root cause rather than have unencrypted or obscured data to enter a computer system and have to correct the problem later.

A method monitors protecting sensitive information. The method executes, on a processor, instructions that cause the processor to perform operations associated with protecting sensitive information. The operations include scanning for potential sensitive information within a data string specific to a user entering information into an electronic form where the potential sensitive information is associated with a person. The potential sensitive information is found within the data string. The method tags, with a machine learning model, the data string with an indication that potential sensitive information is contained within the data string to create tagged sensitive information. A confidence value is assigned with the machine learning model, which indicates the tagged sensitive information is actual sensitive information. The method provides for a human data steward, when the confidence value is below a threshold, an ability to correct whether actual sensitive information is actually contained within the data string.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

“Processor” and “Logic”, as used herein, includes but are not limited to hardware, firmware, software, and/or combinations of each to perform a function(s) or an action(s), and/or to cause a function or action from another logic, method, and/or system to be performed. For example, based on a desired application or need, the logic and/or the processor may include a software-controlled microprocessor, discrete logic, an application specific integrated circuit (ASIC), a programmed logic device, a memory device containing instructions, or the like. The logic and/or the processor may include one or more physical gates, combinations of gates, or other circuit components. The logic and/or the processor may also be fully embodied as software. Where multiple logics and/or processors are described, it may be possible to incorporate the multiple logics and/or processors into one physical logic (or processor). Similarly, where a single logic and/or processor is described, it may be possible to distribute that single logic and/or processor between multiple physical logics and/or processors.

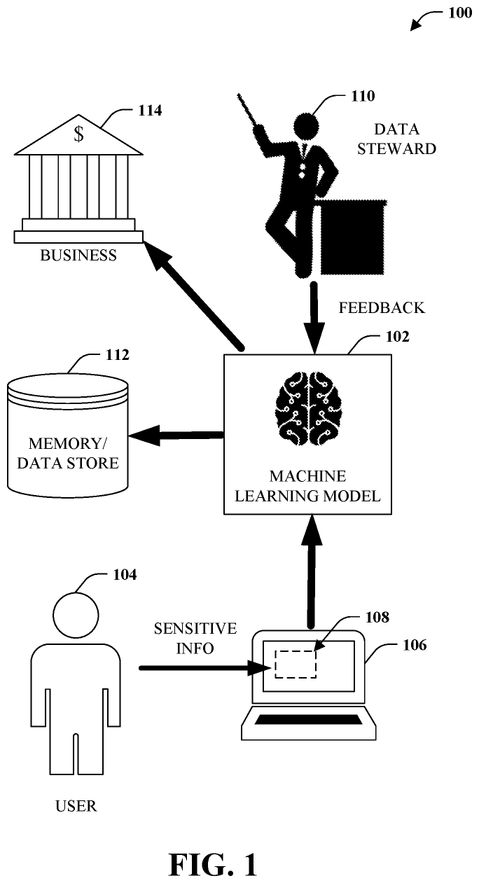

Referring initially to FIG. 1, a high-level overview of an example implementation of a system 100 for detecting sensitive information using a machine learning model 102 is illustrated. Preferably the sensitive information is tagged as sensitive and is properly encrypted or obfuscated at the time of file creation or updating. It is much easier to preemptively prevent the inappropriate or incorrect use of sensitive information rather than trying to correct the inappropriate or incorrect user later. This example implementation includes a user 104 entering information into a computer 106. The user 104 may be entering sensitive information related to an online purchase, a financial transaction, an internet transaction, and the like. The computer 106 may be a laptop, tablet computer, mobile phone, or another electronic device. The user 104 may be entering sensitive information 108, such as personally identifiable information (PII), into a form on the computer 106. The sensitive information 108 may be entered through a webpage, special form, and the like that may be provided to a financial institution, business, school, bank, church, or other organization.

As sensitive information 108 is being entered, or when it is transmitted to the financial institutions, the sensitive information is input into the machine learning model 102 as part of a string of data and possibly may include metadata. The machine learning model 102 looks for the embedded sensitive information 108 that includes other data such as a tag or flag that indicates the string includes sensitive information 108. In other embodiments, the machine learning model 102 may directly tag or change/adjust the tag and a risk score of the sensitive information itself. However, the machine learning model 102 may assign a low-risk score/confidence level to a data string if it is not confident the data string contains sensitive information. When a low-risk score/confidence level is assigned, a data steward 110 may manually review the tagged data and provide feedback to the machine learning model 102 so that the machine learning model 102 may update its model for better performance in the future. When the risk score/confidence level is above a threshold level, there is strong confidence by the machine learning model 102 that the string of data contains sensitive information. With a high-risk score/confidence level, the sensitive information 108 may be masked/encrypted/obfuscated and stored in a memory 112, and the data is masked/encrypted/obfuscated and passed to a destination 114 that is expecting the tagged sensitive information/data string. Catching sensitive information 108 that is incorrectly tagged in this way and having the sensitive information re-tagged properly before it is stored and/or encrypted avoids violating national and international regulations protecting the safe handling of sensitive information.

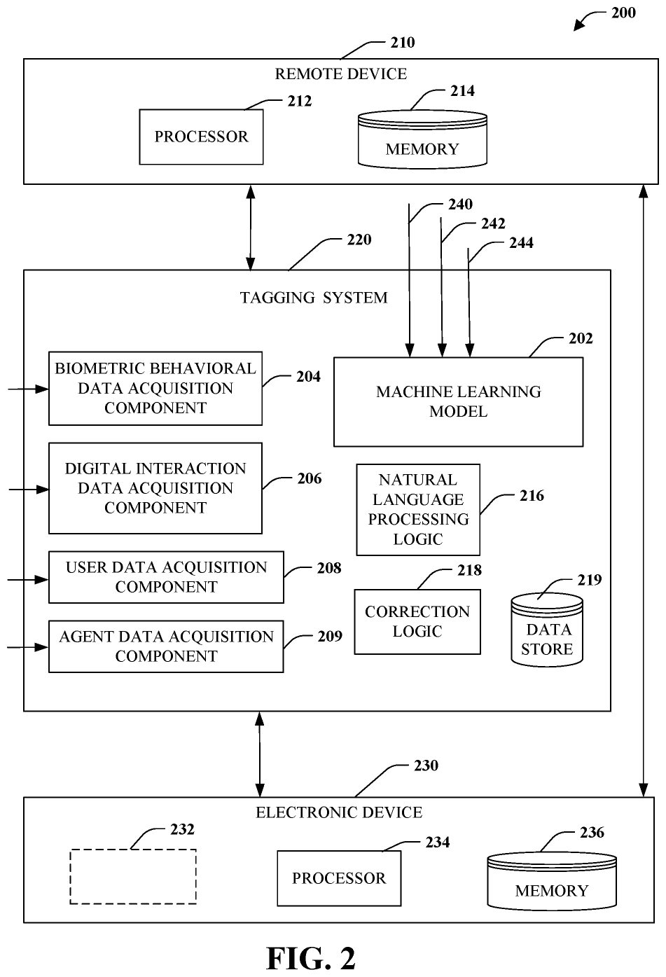

Turning attention to FIG. 2, an example sensitive information tagging system 200 that protects sensitive information 232 is illustrated in further detail. First, the general concept of FIG. 2 is explained along with some of its functionality, then the details of FIG. 2 are explained. The example sensitive information tagging system 200 includes a machine learning model 202 that is part of a tagging system 220 that receives strings of data or datasets or other blocks of data. The strings of data may include metadata 240 that may indicate if the data originated internal or external to an organization and the origin of the data. The metadata 240 may include any transformation of the data, a context around flagged sensitive information contained within the data, volume of the data, etc.

In general, the example sensitive information tagging system 200 uses a tagging system 220 with a machine learning model 202 to determine if sensitive information is actually present in a string of data as indicated by a flag or tag in its metadata 240. The machine learning model 202 uses the flag/tag as well as any possible internal sources, external sources, transformations of the data, or content around the flagged data of the metadata 240 of the string of data to determine if sensitive information is present in the string of data. Natural language processing (NLP) results 242 of data around the string of data, such as a comment field and any notes about recoveries versus acquisitions, may also be used by the machine learning model 202. An internet protocol (IP) address 244 or a device type data when the data was captured may also be used by the machine learning model 202 to determine if sensitive information is present in the string of data. The machine learning model 202 may also use biometric behavior data, user data, customer data, and/or agent data to determine if sensitive information is actually present in a tagged/flagged string of data or a dataset.

The machine learning model 202 uses the input data discussed above and as well as additional data discussed below to determine a new tag of the string of data (or datasets) with a predicted original source of the string of data. This allows for better tracking of where the string of data originated from. For example, the string of data may have originated from an application on a user's phone, originated from a customer agent's software, another customer agent tool, from a “customer”, or from another location. The machine learning model 202 additionally assigns a risk score (e.g., confidence level) to the tagged string of data. When the confidence level/risk score is lower than a threshold, human data stewards may manually accept or reject the tag of the possible sensitive information to improve future predictions because when the machine learning model 202 sees that tag of sensitive information again, it will use the correct tag/flag and make correct or improved decisions.

In more detail, the example sensitive information tagging system 200 collects biometric behavior data, user data, agent data, and/or digital interaction data using a biometric behavior data acquisition component 204, a user data acquisition component 208, an agent data acquisition component 209, and/or a digital interaction data acquisition component 206, respectively. In some configurations, the biometric behavior data acquisition component 204, the user data acquisition component 208, the agent data acquisition component 209, and the digital interaction data acquisition component 206 may be combined together into a single data acquisition logic.

Briefly, the user data includes the characteristics of the person entering sensitive information into a computer. User data creates a unique non-behavioral profile of each end-user (e.g., customer). Agent data includes data about a customer agent that may be interacting with a user. Digital interaction data captures interaction data between the end-user and the customer agent. The user data, agent data, and/or digital interaction data may be used to predict which users, or agents, with a specific non-biometric behavioral data that are more or less likely to input sensitive information inappropriately.

In more detail, user data can include a social security number (SSN), date of birth, Centers for Medicare and Medicate Services (CMS) certification number (CCN), as well as other private identifying information (PII) of an individual. Customer data may include bank account numbers, driver's license numbers, passport numbers, various different types of text IDs, including different versions of SSN IDs in other countries, and sometimes non-personally identifiable information (NPI), fingerprint, voice, iris pattern, and so on, residential location, current job or other title and position within organization hierarchy (e.g., CEO, CTO, CFO, VP, Group Manager, Tech Support Staff, Other Staff), current tasks/projects assigned to the User (e.g., High Level Management, Personnel Management, Management of Finances, Product Management, Customer Support, Bug Diagnose and Fix), normal work hours, normal work locations, average rate of use of enterprise collaborative communication tools; and so on; inaccessibility to direct contact with a customer service representative.

In more detail, agent data can include age, age ranges, gender, location, time of day, response, and time zone. Additionally, other agent data can include lack of knowledge, current job or other title and position within organization hierarchy; normal work hours; normal work locations; average rate of use of enterprise collaborative communication tools; and so on. In other situations, agent data may include statistics on typing bank account numbers in a wrong location, credit card numbers in a wrong location, driver license numbers in a wrong location, passport numbers in a wrong location, various types of number IDs, and the like in wrong locations. Often these numbers are copied and pasted into the wrong field versus being typed into a correct field.

Biometric behavior interaction data can include how fast a user fills out blocks within a standard form, a frequency the user creates typos or other mistakes, how often the user hesitates or pauses within a block of a form, and the like. This behavioral data may be used to predict which users with a specific biometric behavioral data/profiles are more or less likely to input sensitive information inappropriately. For example, biometrical behavioral data may indicate a person may be entering data in a form field extremely quickly. Or a person may be going through a form slowly or hesitating and with lots of pauses, or whatever type of biological behavior. This information/biometric behavior may be used, as discussed below, to display tool tips or some other form of remediation. Instead of placing a tool tip on every single field, the system may just show the tool tip where the mistake is likely to happen. In another example, biometric behavior data may include data concerning a long pause associated with the user receiving a phone call, someone walking up to the user's cubical or office and starts talking with the user, the user leaving to get a cup of coffee, or another reason. Biometric behavior data may include data concerning long pauses that may also be created when a user of a mobile phone receives a text message that distracts the user. Long pauses may also be created when a user switches away from a form to possibly work on another form and then returns to the original form/screen later.

In more detail, digital interaction data can include the time of day, which may be correlated to cause a user or agent to be more prone to incorrectly/inappropriately enter sensitive information. In other instances, the digital interaction data may include data indicating if the time of day is before the user's or agent's lunch time, right after lunch time, day of the week it is, type of weather that may be occurring, what is a weather forecast the user may be aware of, and the like. All of these times or conditions may affect the accuracy of entering sensitive information. The day of the week may affect a person's accuracy of entering sensitive information so that a person may have more errors on a Monday or if it's late on a Friday. The first form an agent works on in the morning may be prone to sensitive information errors, as it is the 400th form late in the day. The day before a holiday and seasonality also may cause sensitive information to be entered incorrectly or less incorrectly depending on aspects of the timing and the individual.

Customers/users and customer agents assisting customers regularly type or copy the sensitive information into the wrong place without knowing that they are incorrectly typing or copying the sensitive information into an incorrect location. By way of example, agents may be required to take notes when assisting some customers, and some agents add too much material on freeform notes and some of that material may be sensitive information. The example system of FIG. 2. may attempt to tag perceived sensitive information to remedy the incorrect placement and/or copying of sensitive information before the electronic document containing the sensitive information is created or stored. Preventing the violation of national or international regulations regarding the proper handling of sensitive information may prevent violations and protect an organization's reputation.

User data, customer data, biological behavior data, and/or user/agent digital interaction data can be used to create unique profiles of end-users based on their typical online behavior when inputting information when interacting with a business computer system, a banking computer system, a secured computer system, or another computer system that may handle sensitive information. User data, customer data, biological behavior data, and/or digital interaction data can be used to coach end users on what they should or should not input into a specific field. In some cases, tool tips or a more interactive chat-bot or overlay is triggered to interact with users and/or show reminders of how to correctly enter personally identifiable information and/or non-personally-identifiable information PII/NPI, and the like to be sure the users correctly enter sensitive information.

The example sensitive information tagging system 200 includes a remote device 210, the tagging system 220, and an electronic device 230. In one example configuration, the remote device 210 displays a merchant-provided webpage. The webpage includes products or services offered for sale by the merchant and includes functionality to support electronic purchases of the products or services. For example, an end-user/customer can interact with the webpage to add items to an electronic shopping cart. To complete the purchase, the customer enters credit card information or other sensitive information that is sent back through the tagging system 220 for further processing.

In one example configuration, the remote device 210 and the electronic device 230 include a remote device processor 212 and an electronic device processor 234, as well as memory 214 and memory 236, respectively. The remote device processor 212 and the electronic device processor 234 may be implemented with solid-state devices such as transistors to create processors that implement functions that can be executed in silicon or other materials. Furthermore, the remote device processor 212 and the electronic device processor 234 may be implemented with general-purpose processors, digital signal processors (DSPs), application-specific integrated circuits (ASICs), field-programmable gate arrays (FPGAs), or other programmable logic devices, discrete gates or transistor logics, discrete hardware components, or any combination thereof designed to perform the functions described herein. A general-purpose processor may be a microprocessor, but in the alternative, the processor may be any processor, controller, microcontroller, or state machine. The remote device processor 212 and the electronic device processor 234 may also be implemented as a combination of computing devices, for example, a combination of a DSP and a microprocessor, a plurality of microprocessors, multi-core processors, one or more microprocessors in conjunction with a DSP core, or any other such configuration as may be appreciated.

The storage devices or memory 214 and memory 236 can be any suitable devices capable of storing and permitting the retrieval of data. In one aspect, the storage devices or memory 214 and memory 236 are capable of storing data representing an original website or multiple related websites. Storage media includes volatile and non-volatile, removable and non-removable media implemented in any method or technology for storage of information. Storage media includes, but is not limited to, storage devices such as memory devices (e.g., random access memory (RAM), read-only memory (ROM), magnetic storage devices (e.g., hard disk, floppy disk, cassettes, tape . . . ), optical disks and other suitable storage devices.

Besides including a biometric behavioral data acquisition component 204, the digital interaction data acquisition component 206, the user data acquisition component 208, the agent data acquisition component 209, the tagging system 220 further includes a machine learning model 202, a tagging logic 216, a correction logic 218, and a data store 219. The biometric behavioral data acquisition component 204, the digital interaction data acquisition component 206, the user data acquisition component 208, the agent data acquisition component 209, the machine learning model 202, the tagging logic 216, and the correction logic 218 can be implemented by a processor coupled to a memory that stores instructions that, when executed, cause the processor to perform the functionality of each component. Further, biometric behavioral data acquisition component 204, the digital interaction data acquisition component 206, the user data acquisition component 208, the agent data acquisition component 209, and the data store 219 can correspond to persistent data structures (e.g., tables) accessible by the machine learning model 202. As such, a computing device is configured to be a special-purpose device or appliance that implements the functionality of the tagging system 220. The biometric behavioral data acquisition component 204, the digital interaction data acquisition component 206, the user data acquisition component 208, the agent data acquisition component 209, the machine learning model 202, the tagging logic 216, and the correction logic 218, as well as the data store 219 can be implemented in silicon or other hardware components so that the hardware and/or software can implement their functionality as described herein.

The biometric behavior data acquisition component 204, the user data acquisition component 208, the agent data acquisition component 209, and the digital interaction data acquisition component 206 provide the biometric behavior data, user data, agent data, and digital interaction data to the analysis and the tagging logic 216 as strings of data. As mentioned above, the biometric behavior data acquisition component 204, the user data acquisition component 208, the agent data acquisition component 209, and the digital interaction data acquisition component 206 may be combined together into a single data acquisition logic. The biometric behavior data acquisition component 204, the user data acquisition component 208, the agent data acquisition component 209, the digital interaction data acquisition component 206, and the data acquisition logic may provide the data to the analysis and the tagging logic 216 as strings of data, as datasets, or as other forms of data. In some configurations, the strings of data may include metadata indicating where the strings of data originated, and the metadata may include other information.

In one configuration, the data acquisition logic receives a string of data associated with a user entering information into an electronic form where the information may contain sensitive information. Of course, the data acquisition logic may alternatively receive datasets, blocks of data, or other forms of data that may contain sensitive information. The sensitive information is related to data that may identify a person, such as personally identifiable information (PII). PII may include a person's name, birthdate, social security number, credit card number, driver's license number, and the like. As discussed above, the data acquisition logic may also receive, associated with the string of data, metadata 240, NLP results 242, and/or an IP address 244. In other instances, the data acquisition logic may receive biometric behavior data, user data, customer data, and/or agent data.

A natural language processing (NLP) logic may perform natural language processing on the string of data containing potential sensitive information and create a NLP context that is associated with data surrounding potential sensitive information. A variety of known implementations of NLP may be used. For example, part-of-speech tagging may introduce the use of hidden Markov models to natural language processing. Statistical models make soft, probabilistic decisions based on attaching real-valued weights to the features making up the input data. Cache language models upon which many speech recognition systems rely are examples of such statistical models.

Neural networks can also be used for NLP. Popular techniques include the use of “word embedding” to capture semantic properties of words, and an increase in end-to-end learning of a higher-level task (e.g., question answering) instead of relying on a pipeline of separate intermediate tasks (e.g., part-of-speech tagging and dependency parsing). In another neural network technique, the term “neural machine translation” (NMT) emphasizes the fact that deep learning-based approaches to machine translation directly learn sequence-to-sequence transformations, obviating the need for intermediate steps such as word alignment and language modeling that may be used in statistical machine translation (SMT). Some neural network techniques tend to use the non-technical structure of a given task to build a proper neural network.

After the NLP logic creates a NLP context that is associated with data surrounding potential sensitive information, the machine learning model 202 is invoked to use NLP context to tag the potential sensitive information and to calculate a confidence level of the tag. In some configurations, the string of data may have been tagged before it was received by the data acquisition logic, and the machine learning model 202 uses this tag as input and re-evaluates the tag contained in the metadata 240 and updates/re-tags that tag. As discussed above, a variety of inputs may be input into the machine learning model 202. An internet protocol (IP) 244 address or a device type data when the data was captured may also be used by the machine learning model 202 to determine if sensitive information is present in the string of data. The machine learning model 202 may also use biometric behavior data, user data, customer data, and/or agent data to determine if sensitive information is actually present in a tagged/flagged string of data or a dataset.

The machine learning model 202 additionally assigns a risk score (e.g., confidence level) to the tagged string of data. When the confidence level/risk score is lower than a threshold, human data stewards may manually accept or reject the tag of the possible sensitive information to improve future predictions because when the machine learning model 202 sees that tag of sensitive information again, it will use the correct tag/flag and make corrected or improved decisions. The confidence level/risk score may, in some aspects, indicate how confident the machine learning model 202 is about the keywords.

The correction logic 218 provides, when the confidence level is below a threshold value, an option for a human data steward to correct the tag of the string of data as containing sensitive information and provides for a tagged string of data that is more accurate when used. The tagging system 220 may originally input original metadata on data with originally assigned tags, sensitive information, and/or a confidence level. The example sensitive information tagging system 200 may use data that was automatically tagging data sets based on where the data came from, who generated the data, what type of data, instead of/without having the data steward take any action the data may be auto-tagged based on specific keywords. Alternatively, research may be conducted by human “performance data stewards”. “Performance data stewards” manage data and make sure it is of good quality, and if there are violations of sensitive information not being in the right place the “performance data stewards” tag the data and remediate the data to create more data about data (e.g., metadata about data or data about data).

For low scores, data stewards can validate the prediction and accept/reject that data as sensitive to improve future predictions. One goal of the tagging system 220/machine learning model 202 is to use keywords to determine where there is a high volume of incorrect use of sensitive information and implement solutions to solve the problem of incorrectly using sensitive information at a corresponding root cause/origin. This can be a distributed federated type of machine learning model in some instances.

The tagging system 220 may speed up the process of teaching the machine learning model 202 to provide accurate tagging and high confidence levels. This, in turn, provides for a tagging system 220 that is more useable in terms of “to date the lineage” and having accurate keywords in the metadata that indicate the sensitive information came from the agent tool, or the sensitive information came from an application, or the sensitive information came from another specified origin. Having better tagging information makes it easier for the data store 219, or logic within the data store 219, to determine where the flagged sensitive information came from or if flagged sensitive information is something that can be masked, tokenized, or encrypted.

In some aspects, the output of the model would automatically tag strings of data or datasets with a predicted origin source for better tracking of where the detected sensitive information came from. These can, for example, be the keywords “agent call center”, “agent tool”, “customer/user”, and the like. A goal of the tagging system 220 may be to use the keywords to determine where there is a high volume of violations of the improper use of sensitive information or the tagging of sensitive information and to provide data for the implementation of a solution or to implement solutions to solve these problems at the root cause.

The machine learning model 202 is operable to analyze the input of sensitive information and compute a risk score and determine if the risk score crosses a threshold level (e.g., exceeds a threshold level). The risk score is a value that indicates the likelihood that an item on a form, website, or the like, was sensitive information that was entered incorrectly. In other words, the risk score is a value that captures the probability that sensitive information was entered incorrectly. For example, the machine learning model 202 can employ one or more rules to compute the risk score.

Various portions of the disclosed systems above and methods below can include or employ artificial intelligence or knowledge or rule-based components, sub-components, processes, means, methodologies, or mechanisms (e.g., support vector machines, neural networks, expert systems, Bayesian belief networks, fuzzy logic, data fusion engines, classifiers). Such components, among others, can automate certain mechanisms or processes performed thereby, making portions of the systems and methods more adaptive as well as efficient and intelligent. By way of example, and not limitation, the machine learning model 202 can employ such mechanisms to automatically determine a risk score that is associated with the risk of sensitive information being placed in the wrong location or if the sensitive information should have been entered into a form or webpage at all.

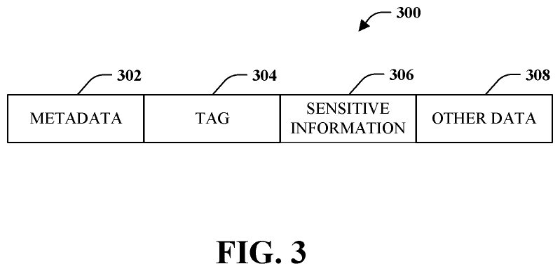

FIG. 3 illustrates an example string of data 300. The string of data may take other forms, such as a dataset, data-block, data packet, and the like. The example string of data 300 is illustrated with a preamble of metadata 302. This is followed by a tag of sensitive information 304. The sensitive information 306 follows that tag of sensitive information 304. Other data 308 in the string of data follows the sensitive information 306. In other instances, additional and/or different other data may be included between the metadata 302 and the tag of sensitive information 304.

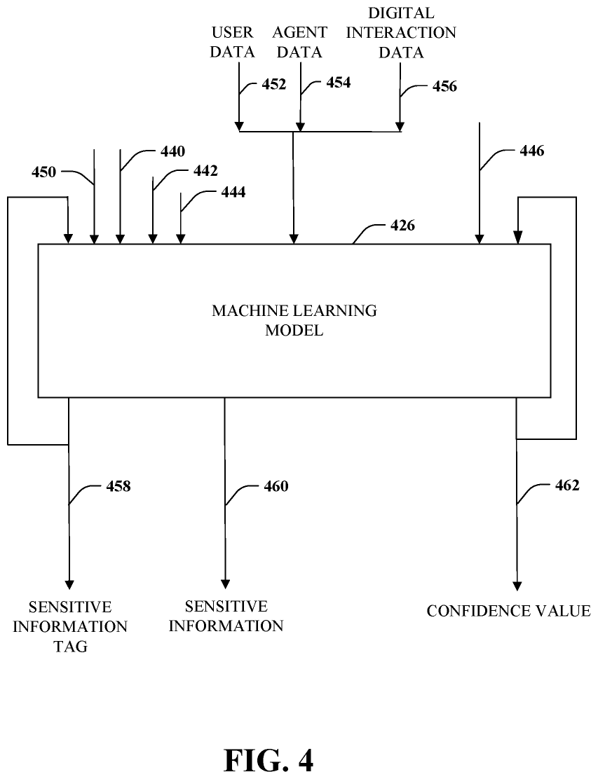

FIG. 4 depicts the machine learning model 426 in accordance with an example embodiment. The machine learning model 426 tags strings of data, datasets, blocks of data, and the like that contain sensitive information. The machine learning model 426 may also assign a confidence value 462 (e.g., risk score) to each tag. In another possible instance, the machine learning model 426 is used to prevent end computer system users from accidentally incorrectly inputting and submitting sensitive information. This helps to prevent users from incorrectly entering sensitive information at the source and eliminates the requirement of cleaning up incorrectly entered sensitive information after the sensitive information has already been committed to a form, stored in memory, or the like.

Biometric behavior data 450 are a primary input to the machine learning model 426. Instead of looking at a profile of the person, biometric behavior captures a profile of the person's behavior profile. Non-biometric behavior data are also a primary input into the machine learning model 426. In general, non-biometric behavior data captures a profile unique to an individual. Non-biometric behavior data may include three types of data. This data includes user information 452 (or customer information), agent information 454, and digital interaction data 456. Metadata 440, as well as natural language processing (NLP), and results 442 may also be input into the machine learning model 426. Metadata 440 and NLP results 442 are data around the string of data such as a comment field, any notes about recoveries vs. acquisitions may also be used by the machine learning model 426. An internet protocol (IP) address 444 is also input to the machine learning model 426, with the IP address 444 being a device type data when the data was captured that may also be used by the machine learning model 426 to determine if sensitive information is present in the string of data. Data steward feedback 446 is also input to the machine learning model. As mentioned above, data stewards are humans that check tagged sensitive information with a low confidence value/level and correct and/or provide other feedback to the tagging data and the machine learning model 426.

The machine learning model 426 is trained on the data discussed above for tagging strings of data that contain sensitive information and produces a confidence value 462 associated with each tag. The machine learning model 426 outputs a tag of whether sensitive information is contained within a string of data (sensitive information tag 458). The machine learning model 426 also outputs the sensitive information 460 that may have been incorrectly entered. The machine learning model 426 also outputs a confidence value/risk score that indicates how confident the machine learning model 426 is that the tag is correct. Based on the confidence value, a human data steward may manually check a tag and accept or reject the tag assigned by the machine learning model 426.

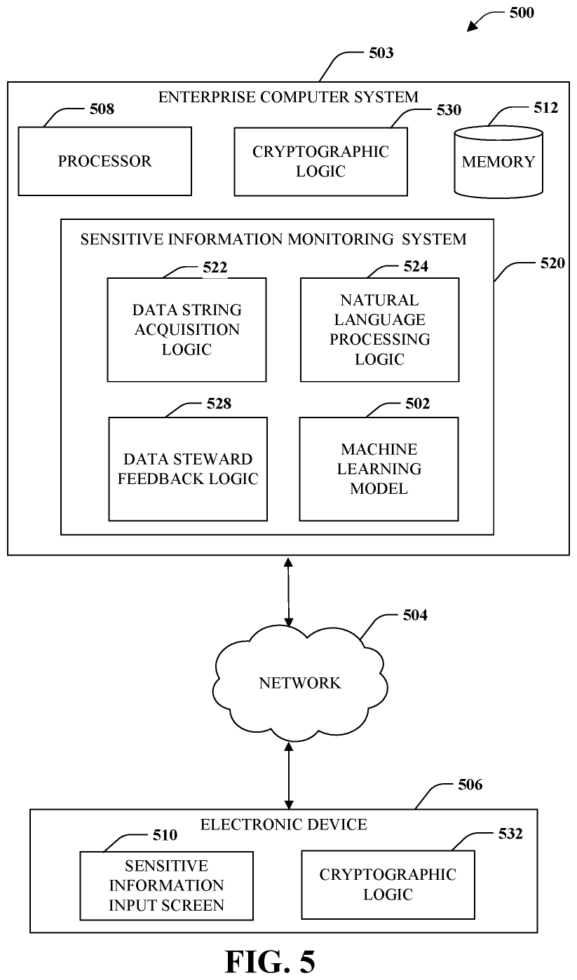

FIG. 5 illustrates another example system 500 for tagging sensitive information that was entered into an electronic form, website, an electronic device, and the like. The example system 500 includes an enterprise computer system 503, a network 504, and an electronic device 506. In some configurations, the sensitive information monitoring system 520 may, instead, be located in the electronic device 506.

The network 504 allows the enterprise computer system 503 and the electronic device 506 to communicate with each other. The network 504 may include portions of a local area network such as an Ethernet, portions of a wide area network such as the Internet, and may be a wired, optical, or wireless network. The network 504 may include other components and software as may be appreciated in other implementations.

The enterprise computer system 503 includes a processor 508, cryptographic logic 530, a memory 512, and a sensitive information monitoring system 520. The processor 508 may be implemented with solid-state devices such as transistors to create a processor that implements functions that can be executed in silicon or other materials. Furthermore, the processor 508 may be implemented with a general-purpose processor, a digital signal processor (DSP), an application-specific integrated circuit (ASIC), a field-programmable gate array (FPGA), or another programmable logic device, discrete gates or transistor logics, discrete hardware components, or any combination thereof designed to perform the functions described herein.

The memory 512 can be any suitable device capable of storing and permitting the retrieval of data. In one aspect, the memory 512 is capable of storing sensitive information input to an electronic form, a website, software, or in another way. Storage media includes volatile and non-volatile, removable and non-removable media implemented in any method or technology for storage of information. Storage media includes, but is not limited to, storage devices such as memory devices (e.g., random access memory (RAM), read-only memory (ROM), magnetic storage devices (e.g., hard disk, floppy disk, cassettes, tape . . . ), optical disks and other suitable storage devices.

The electronic device 506 includes a sensitive information input screen 510 and cryptographic logic 532. The sensitive information input screen 510 may be any suitable software such as a website page, electronic form, or another display on the electronic device 506 for entering sensitive information. In some embodiments, the sensitive information input screen 510 may include an audio input device such as a microphone that may be spoken into or any other device that captures a user's thoughts and that converts the thoughts into an electronic format.

Cryptographic logic 530 and cryptographic logic 532 in the enterprise computer system 503 and the electronic device 506, respectively, allow the enterprise computer system 503 and the electronic device 506 to send encrypted data including sensitive information and personally identifiable information (PII) between them. Cryptographic logic 530 and cryptographic logic 532 are operable to produce encrypted sensitive information by way of an encryption algorithm or function. The cryptographic logic 532 of the electronic device 506 can receive, retrieve, or otherwise obtain the sensitive information from the sensitive information input screen 510. An encryption algorithm is subsequently executed to produce an encrypted value representative of the encoded sensitive information. Stated differently, the original plaintext of the combination of encoded sensitive information is encoded into an alternate cipher text form. For example, the Advanced Encryption Standards (AES), Data Encryption Standard (DES), or another suitable encryption standard or algorithm may be used. In one instance, symmetric-key encryption can be employed in which a single key both encrypts and decrypts data. The key can be saved locally or otherwise made accessible by cryptographic logic 530 and cryptographic logic 532. Of course, an asymmetric-key encryption can also be employed in which different keys are used to encrypt and decrypt data. For example, a public key for a destination downstream function can be utilized to encrypt the data. In this way, the data can be decrypted downstream at a user device, as mentioned earlier, utilizing a corresponding private key of a function to decrypt the data. Alternatively, a downstream function could use its public key to encrypt known data.

The example system 500 may provide an additional level of security to the encoded data by digitally signing the encrypted sensitive information. Digital signatures employ asymmetric cryptography. In many instances, digital signatures provide a layer of validation and security to messages (i.e., sensitive information) sent through a non-secure channel. Properly implemented, a digital signature gives the receiver reason to believe the message was sent by the claimed sender.

Digital signature schemes, in the sense used here, are cryptographically based, and must be implemented properly to be effective. Digital signatures can also provide non-repudiation, meaning that the signer cannot successfully claim they did not sign a message, while also claiming their private key remains secret. In one aspect, some non-repudiation schemes offer a timestamp for the digital signature, so that even if the private key is exposed, the signature is valid.

Digitally signed messages may be anything representable as a bit-string such as encrypted sensitive information. Cryptographic logic 530 and cryptographic logic 532 may use signature algorithms such as RSA (Rivest-Shamir-Adleman), which is a public-key cryptosystem that is widely used for secure data transmission. Alternatively, the Digital Signature Algorithm (DSA), a Federal Information Processing Standard for digital signatures, based on the mathematical concept of modular exponentiation and the discrete logarithm problem may be used. Other instances of the signature logic may use other suitable signature algorithms and functions.

The sensitive information monitoring system 520 includes a data string acquisition logic 522, a natural language processing logic 524, a machine learning model 502, and a data steward feedback logic 528. The data string acquisition logic 522, the natural language processing logic 524, and the machine learning model 502 can be implemented by a processor coupled to a memory that stores instructions that, when executed, cause the processor to perform the functionality of each component or logic. The data string acquisition logic 522, the natural language processing logic 524, and the machine learning model 502 can be implemented in silicon or other hardware components so that the hardware and/or software can implement their functionality as described herein.

In one aspect, the data string acquisition logic 522 receives a string of data associated with a user entering information into an electronic form where the information may contain sensitive information. Of course, the data string acquisition logic 522 may alternatively receive datasets, blocks of data, or other forms of data that may contain sensitive information. The data string acquisition logic 522 also receives metadata associated with the string of data. In some instances, the data string acquisition logic 522 may receive biometric behavior data, non-biometric behavior user data, customer data, and/or agent data.

The natural language processing logic 524 performs natural language processing (NLP) on the string of data containing potential sensitive information and provides a NLP context that is associated with data surrounding potential sensitive information to the machine learning model 502. The machine learning model 502 is invoked to use the NLP context to tag the potential sensitive information that calculates a confidence level of the tag. The example system 500 provides, when the confidence level is below a threshold value, an option for a human data steward to correct the tag of the string of data as containing sensitive information so that a tag string of data is more accurate. The data steward feedback logic 528 may receive this steward feedback and train the machine learning model 502 on the steward feedback.

The aforementioned systems, architectures, platforms, environments, or the like have been described with respect to interaction between several logics and components. It should be appreciated that such systems and components can include those logics and/or components or sub-components and/or sub-logics specified therein, some of the specified components or logics or sub-components or sub-logics, and/or additional components or logics. Sub-components could also be implemented as components or logics communicatively coupled to other components or logics rather than included within parent components. Further yet, one or more components or logics and/or sub-components or sub-logics may be combined into a single component or logic to provide aggregate functionality. Communication between systems, components or logics and/or sub-components or sub-logics can be accomplished following either a push and/or pull control model. The components or logics may also interact with one or more other components not specifically described herein for the sake of brevity but known by those of skill in the art.

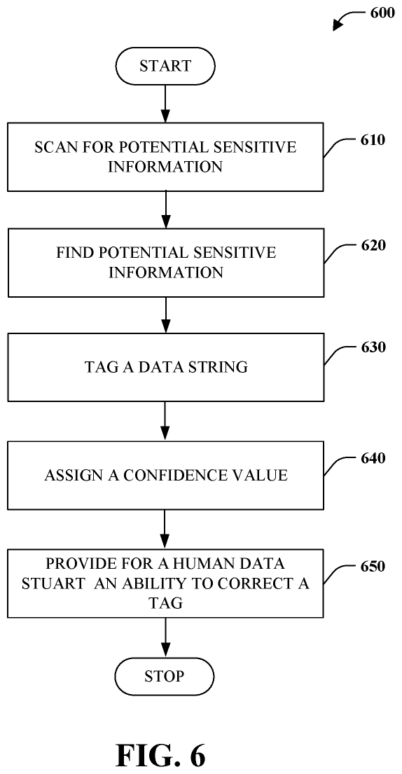

In view of the example systems described above, methods that may be implemented in accordance with the disclosed subject matter will be better appreciated with reference to flow chart diagrams of FIGS. 6-8. While for purposes of simplicity of explanation, the methods are shown and described as a series of blocks, it is to be understood and appreciated that the disclosed subject matter is not limited by the order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

Turning attention to FIG. 6, a method 600 for protecting sensitive information is depicted in accordance with an aspect of this disclosure. The method 600 for protecting sensitive information may execute instructions on a processor that cause the processor to perform operations associated with the method.

At reference number 610, the method 600 scans for potential sensitive information. The method 600 may scan for sensitive information that is personally identifiable information (PII). The sensitive information may be within a data string, data block, a packet, and the like. The data string is specific to a user entering information into an electronic form where the potential sensitive information is associated with a person;

Potential sensitive information is found at reference number 620 within the data string. The sensitive information may be found or not by parsing the data string. In one instance, the sensitive information may be found using natural language processing. Alternatively, the sensitive information may be found using keywords.

The data string may be tagged at reference number 630. The tagging may be performed with a machine learning model. The data string tag may provide other indications that potential sensitive information is contained within the data string.

A confidence value is assigned at reference number 640. The confidence value is created by the machine learning model. The confidence value indicates how strongly the machine learning model is that the tagged sensitive information is actually sensitive information in the data set. In some configurations, the machine learning model is triggered to assign the confidence value based on the tagged sensitive information. The sensitive information may have been previously tagged but can be re-tagged by the machine learning model.

The method 600 provides an ability for a human data steward to correct a tag at reference number 650. The ability of a human data steward to correct a tag is provided when the confidence value exceeds a threshold. The tag indicates whether actual sensitive information is contained within the data string. The machine learning model may be trained with information associated with information provided by the human data steward. When there is sensitive information present in the dataset, the method 600 obfuscates the sensitive information before the actual sensitive information is transmitted or stored so that the actual sensitive information is not disclosed to third parties. Alternatively, when there is sensitive information present in the dataset, the method 600 may encrypt the sensitive information. In other configurations, the tagged sensitive information and the confidence value may be used as inputs to train the machine learning model with a convolutional neural network (CNN).

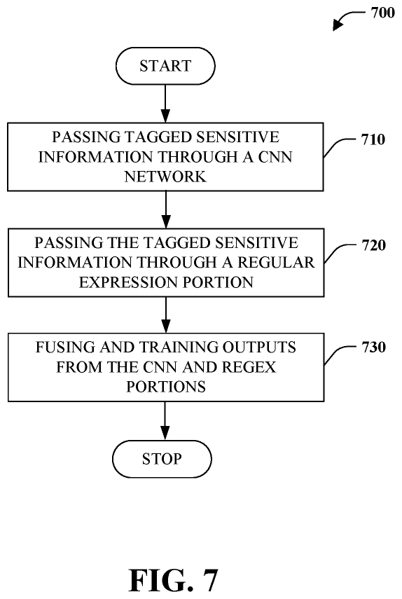

FIG. 7 depicts a method 700 for protecting sensitive information by training a machine learning model using tags. The method 700 can be implemented and performed by the example sensitive information tagging system 200 of FIG. 2 for protecting sensitive information by using data tags.

At reference numeral 710, the method 700 passes tagged sensitive information through a convolutional neural network (CNN) portion of the machine learning model. The method corrects tags of the sensitive information, at reference numeral 720. The method 700 trains output from the CNN, at reference number 730, on the human data steward corrections to create a final prediction output from the machine learning model. The human data stewards may analyze tagged sensitive information within strings of data, datasets, and the like, to be sure the tags accurately match with sensitive information.

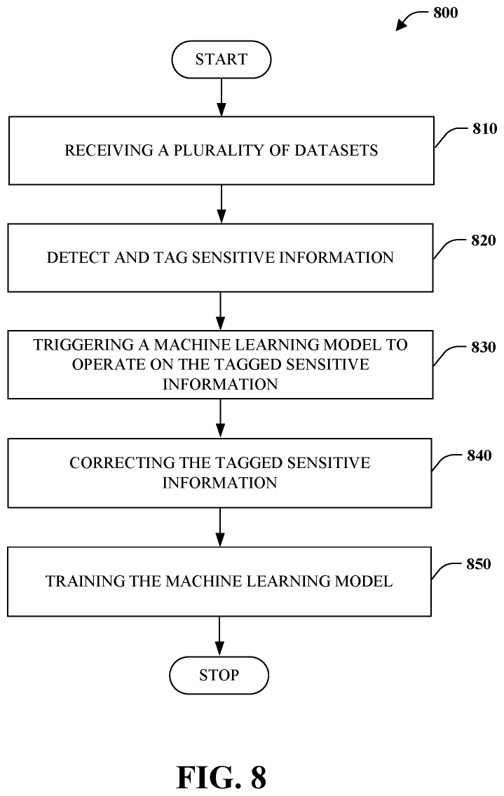

FIG. 8 depicts an example method 800 of protecting sensitive information. The example method 800 can be performed by the example system 500 of FIG. 5 for protecting sensitive information that has been entered into an electronic form, website, an electronic device, and the like, as discussed above.

At reference numeral 810, a plurality of datasets is received. The plurality of datasets is associated with a user entering information into an electronic form that may contain sensitive information. The example method 800 may receive a string of data containing user data, agent data, biometric behavior data, or digital input data.

The sensitive information is detected and tagged at reference numeral 820. The plurality of datasets is detected and tagged to produce tagged sensitive information. In some instances, the detecting and tagging sensitive information in the plurality of datasets may be performed using natural language processing. The example method 800 triggers, at reference numeral 830, a machine learning model to operate on the tagged sensitive information to produce at least a confidence value.

The example method 800 corrects, by the machine learning model, at reference numeral 840 a tag. The tagged sensitive information is used to produce corrected tagged datasets when the confidence value crosses a threshold level. The machine learning model is trained on the corrected tagged datasets at reference numeral 850. In some aspects, the tagged sensitive information and the risk score are used as inputs to train the machine learning model with a convolutional neural network (CNN).

The term “data steward” refers to a role associated with oversight and data governance within an organization. A data steward can be responsible for ensuring the quality and fitness of data assets including metadata for such data assets. A data steward can be responsible for ensuring data is compliant with policy, regulatory obligations or both. In accordance with one embodiment, a data steward can correspond to a human as discussed herein. However, a data steward can also be a computing entity (e.g., machine learning model, bot) that performs operations automatically without human intervention. Further, a data steward can be a combination of a human user and automated functionality.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be but is not limited to being a process running on a processor, a processor, an object, an instance, an executable, a thread of execution, a program, and/or a computer. By way of illustration, both an application running on a computer and the computer can be a component. One or more components may reside within a process and/or thread of execution, and a component may be localized on one computer and/or distributed between two or more computers.

The conjunction “or” as used in this description and appended claims is intended to mean an inclusive “or” rather than an exclusive “or,” unless otherwise specified or clear from the context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

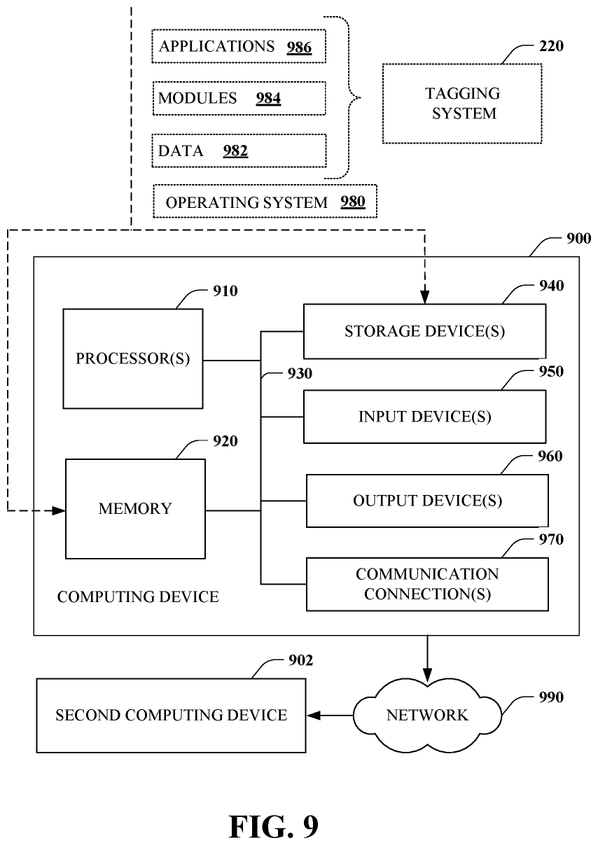

To provide a context for the disclosed subject matter, FIG. 9, as well as the following discussion, are intended to provide a brief, general description of a suitable environment in which various aspects of the disclosed subject matter can be implemented. However, the suitable environment is solely an example and is not intended to suggest any limitation on scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules may be located in one or both of local and remote memory devices.

With reference to FIG. 9, illustrated is an example computing device 900 (e.g., desktop, laptop, tablet, watch, server, hand-held, programmable consumer or industrial electronics, set-top box, game system, compute node). The computing device 900 includes one or more processor(s) 910, memory 920, system bus 930, storage device(s) 940, input device(s) 950, output device(s) 960, and communications connection(s) 970. The system bus 930 communicatively couples at least the above system constituents. However, the computing device 900, in its simplest form, can include one or more processors 910 coupled to memory 920, wherein the one or more processors 910 execute various computer-executable actions, instructions, and or components stored in the memory 920.

The processor(s) 910 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 910 may also be implemented as a combination of computing devices, for example, a combination of a DSP and a microprocessor, a plurality of microprocessors, multi-core processors, one or more microprocessors in conjunction with a DSP core, or any other such configuration. In one configuration, the processor(s) 910 can be a graphics processor unit (GPU) that performs calculations concerning digital image processing and computer graphics.

The computing device 900 can include or otherwise interact with a variety of computer-readable media to facilitate control of the computing device to implement one or more aspects of the disclosed subject matter. The computer-readable media can be any available media accessible to the computing device 900 and includes volatile and non-volatile media, and removable and non-removable media. Computer-readable media can comprise two distinct and mutually exclusive types: storage media and communication media.

Storage media includes volatile and non-volatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM), magnetic storage devices (e.g., hard disk, floppy disk, cassettes, tape), optical disks (e.g., compact disk (CD), digital versatile disk (DVD) . . . ), and solid-state devices (e.g., solid-state drive (SSD), flash memory drive (e.g., card, stick, key drive)), or any other like mediums that store, as opposed to transmit or communicate, the desired information accessible by the computing device 900. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 920 and storage device(s) 940 are examples of computer-readable storage media. Depending on the configuration and type of computing device, the memory 920 may be volatile (e.g., random access memory (RAM)), non-volatile (e.g., read only memory (ROM), flash memory), or some combination of the two. By way of example, the basic input/output system (BIOS), including basic routines to transfer information between elements within the computing device 900, such as during start-up, can be stored in non-volatile memory, while volatile memory can act as external cache memory to facilitate processing by the processor(s) 910, among other things.

The storage device(s) 940 include removable/non-removable, volatile/non-volatile storage media for storage of vast amounts of data relative to the memory 920. For example, storage device(s) 940 include, but are not limited to, one or more devices such as a magnetic or optical disk drive, floppy disk drive, flash memory, solid-state drive, or memory stick.

Memory 920 and storage device(s) 940 can include, or have stored therein, operating system 980, one or more applications 986, one or more program modules 984, and data 982. The operating system 980 acts to control and allocate resources of the computing device 900. Applications 986 include one or both of system and application software and can exploit management of resources by the operating system 980 through program modules 984 and data 982 stored in the memory 920 and/or storage device(s) 940 to perform one or more actions. Accordingly, applications 986 can turn a general-purpose computer 900 into a specialized machine in accordance with the logic provided thereby.

All or portions of the disclosed subject matter can be implemented using standard programming and/or engineering techniques to produce software, firmware, hardware, or any combination thereof to control the computing device 900 to realize the disclosed functionality. By way of example and not limitation, all or portions of the tagging system 220 can be, or form part of, the application 986, and include one or more program modules 984 and data 982 stored in memory and/or storage device(s) 940 whose functionality can be realized when executed by one or more processor(s) 910.

In accordance with one particular configuration, the processor(s) 910 can correspond to a system on a chip (SOC) or like architecture including, or in other words integrating, both hardware and software on a single integrated circuit substrate. Here, the processor(s) 910 can include one or more processors as well as memory at least similar to the processor(s) 910 and memory 920, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, the tagging system 220 and/or functionality associated therewith can be embedded within hardware in a SOC architecture.

The input device(s) 950 and output device(s) 960 can be communicatively coupled to the computing device 900. By way of example, the input device(s) 950 can include a pointing device (e.g., mouse, trackball, stylus, pen, touchpad), keyboard, joystick, microphone, voice user interface system, camera, motion sensor, and a global positioning satellite (GPS) receiver and transmitter, among other things. The output device(s) 960, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 950 and output device(s) 960 can be connected to the computing device 900 by way of wired connection (e.g., bus), wireless connection (e.g., Wi-Fi, Bluetooth), or a combination thereof.

The computing device 900 can also include communication connection(s) 970 to enable communication with at least a second computing device 902 utilizing a network 990. The communication connection(s) 970 can include wired or wireless communication mechanisms to support network communication. The network 990 can correspond to a local area network (LAN) or a wide area network (WAN) such as the Internet. The second computing device 902 can be another processor-based device with which the computing device 900 can interact. In one instance, the computing device 900 can execute a tagging system 220 for a first function, and the second computing device 902 can execute a tagging system 220 for a second function in a distributed processing environment. Further, the second computing device can provide a network-accessible service that stores source code, and encryption keys, among other things that can be employed by the tagging system 220 executing on the computing device 900.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A system, comprising:
a processor coupled to memory that includes instructions that, when executed by the processor, cause the processor to:
scan a data string for sensitive data entered into an electronic form;
identify the sensitive data within the data string;
collect context information regarding a user entering the data;
invoke a machine learning model that is trained to automatically determine a tag based on the context information and a confidence score associated with the tag;
add the tag to data string metadata;
compare the confidence score to a predetermined threshold; and
prompt a data steward to evaluate and correct the tag when the confidence score satisfies the predetermined threshold.

2. The system of claim 1, wherein the instructions further cause the processor to invoke a second machine learning model trained to identify the sensitive data within the data string.

3. The system of claim 1, wherein the instructions further cause the processor to at least one of mask, encrypt, or obfuscate the sensitive data before the sensitive data is transmitted or stored.

4. The system of claim 1, wherein the electronic form is presented on a web page.

5. The system of claim 1, wherein the user entering the data is a customer service agent.

6. The system of claim 1, wherein the context information comprises at least one of a position within an organizational hierarchy, work hours, work location, or time of day.

7. The system of claim 1, wherein the context information comprises one or more statics regarding historical entry accuracy.

8. The system of claim 1, wherein the context information comprises biometric behavior interaction data.

9. The system of claim 1, wherein the instructions further cause the processor to update the machine learning model based on input provided by the data steward.

10. The system of claim 1, wherein the sensitive data comprises personally identifiable information.

11. A method, comprising:
executing on at least one processor instructions that cause the at least one processor to perform operations, comprising:
identifying sensitive data in a data string entered into an electronic form;
acquiring context information regarding a user entering the data in the electronic form;
invoking a machine learning model that is trained to automatically determine a tag based on the context information and provide a confidence score associated with the tag;
adding the tag to data string metadata;
comparing the confidence score to a predetermined threshold; and
prompting a data steward to evaluate and correct the tag when the confidence score satisfies the predetermined threshold.

12. The method of claim 11, wherein the operations further comprise performing natural language processing to identify the sensitive data.

13. The method of claim 11, wherein the operations further comprise identifying the sensitive data entered into an unprotected form field that is transmitted or stored in an unaltered state.

14. The method of claim 13, wherein the operations further comprise identifying the sensitive data entered into a comment form field.

15. The method of claim 11, wherein the operations further comprise at least one of masking, encrypting, or obfuscating the sensitive data before the sensitive data is transmitted or stored.

16. The method of claim 11, wherein the operations further comprise updating the machine learning model based on input from the data steward.

17. The method of claim 11, wherein the operations further comprise invoking a convolutional neural network as the machine learning model.

18. A computer-implemented method, comprising:
identifying sensitive data in a data string in an electronic form field;
determining context information regarding a user entering the data into the electronic form field;
executing a machine learning model trained to automatically determine a keyword based on the context information and produce a confidence score associated with the keyword;
adding the keyword to data string metadata; and
prompting a data steward to evaluate and correct the keyword when the confidence score satisfies a predetermined threshold.

19. The computer-implemented method of claim 18, further comprising determining at least one position within an organizational hierarchy, work hours, work location, time of data, historical entry accuracy, or biometric behavior interaction data as the context information.

20. The computer-implemented method of claim 18, further comprising initiating root cause analysis with respect to incorrect input of sensitive data based on the keyword.
